(19) United States
(12) Patent Application Publication
(10) Pub. No.: US 2013/0025529 A1
(43) Pub. Date: Jan. 31, 2013

(54) Illustrative Label Measurement System For A Container

(71) Applicant: Stephen M. Key, Modesto, CA (US)

(72) Inventor: Stephen M. Key, Modesto, CA (US)

(21) Appl. No.: 13/558,278

(22) Filed: Jul. 25, 2012

Related U.S. Application Data
(60) Provisional application No. 61/511,764, filed on Jul. 26, 2011.

(51) Int. Cl. G01F 23/02

(52) U.S. Cl. 116/201; 116/227

(57) ABSTRACT

The present application is directed to illustrative label measurement systems for a container and methods thereof. A base label may be adhered to the container, and measurement information displayed on the base label. A top label may cover at least a portion of the base label. The top label may be rotatable about the base label to a specific unit of measurement. The top label may have a transparent window allowing measurement information for the specific unit of measurement to be visible through the transparent window and a second transparent window allowing a gradient line associated with the specific unit of measurement to be visible through the second transparent window.

### CROSS-REFERENCE TO RELATED APPLICATIONS

The present application claims priority to provisional U.S. Patent Application Ser. No. 61/511,764, filed on Jul. 26, 2011, titled “Illustrative Package to Instruct the Proper Dosage of Medication,” which is hereby incorporated by reference in its entirety.

### FIELD OF THE INVENTION

The present application is directed generally to labels, and more specifically to labels for consumer product containers that illustrate the correct dosage of medication.

### BACKGROUND

Containers for consumer products have a limited amount of outer surface area for placement of labels on the container. This may pose a challenge to manufacturers of these consumer products to fit all of the information they want to deliver to the consumer, or are required by law to deliver to the consumer, in this limited area. In particular, packaging for prescription medications may be required to specify a significant amount of information concerning dosage and frequency of consumption.

More than three billion prescriptions are written each year in the United States, and an estimated $18 billion is spent on over-the-counter medications. Both prescription and over-the-counter medications are intended to be consumed by a patient according to specific instructions for dosage and frequency. Non-compliance with these instructions has been identified as a major obstacle to the effective delivery of health care. Compliance typically means consuming the correct dosage at the correct frequency as specified in the prescription or on the over-the-counter medication packaging. According to the World Health Organization, only about half of patients with chronic diseases living in developed countries comply with their medication instructions. The reasons for non-compliance are varied, ranging from simple forgetfulness, to confusion, to ambivalence. However, the effects of non-compliance are staggering, resulting in an estimated $290 billion dollars per year in avoidable medical expenses. Additionally, studies have shown that non-compliance results in about 125,000 deaths annually in the United States, and leads to 10-25 percent of hospital and nursing home admissions.

Many liquid medications are packaged and sold with some type of dose-dispensing device that may be used to accurately measure the recommended dose based on instructions on the label, product packaging, or separate printed literature included with the package. However, consumers may not use the dose-dispensing device included with the package. For example, the instructions for a medication may indicate the dosage in teaspoon or tablespoon amounts. The consumer may use a household spoon instead of the dose-dispensing device. These spoons are not necessarily meant to accurately measure a teaspoon or tablespoon amount, and overdosing or underdoing may occur.

In addition, some consumers may not be able to read the proper dosing instructions provided in text form with the medication because of vision problems or illiteracy. In other situations, the units of measure specified in the instructions may not match the units of measure on the dose-dispensing device. When the medication is in pill, tablet, or capsule form, the consumer may not understand how many pills constitute a dose.

### SUMMARY

The present application is directed to illustrative rotating label measurement systems for a container. An exemplary illustrative label measurement system may comprise a base label adhered to the container. The base label may have a back surface and a front surface, with measurement information and gradient lines associated with the gradient information printed on the front surface. The illustrative label measurement system may further comprise a top label covering at least a portion of the front surface of the base label. The top label may be rotatable about the base label. In various embodiments, the top label may have a transparent window allowing at least a portion of the printed measurement information to be displayed through the transparent window. Rotation of the top label may cause the transparent window to display measurement information for a specific unit of measurement. Various embodiments may comprise a second transparent window to display the gradient line associated with the specific unit of measurement displayed in the transparent window.

According to additional exemplary embodiments, the present application may be directed to methods for measuring material dispensed from a container. An exemplary method may comprise adhering a base label having a back surface and a front surface to the container, with units of measurement and gradient lines associated with the units of measurement printed on the front surface of the base label. At least a portion of the front surface of the base label may be covered by a rotating top label. A transparent window may be placed within the rotating top label, such that at least a portion of the units of measurement may be visible through the transparent window. The top label may be allowed to rotate to a specific unit of measurement, and an indicia associated with the specific unit of measurement may be displayed. In various embodiments, a second transparent window may be placed within the rotating top label, such that a gradient line associated with the specific unit of measurement is displayed in the second transparent window when the specific unit of measurement is displayed in the transparent window. An opening on the container for dispensing material may be provided, and the material may be dispensed until it is dispensed at or near an amount approximated by the indicia.

### BRIEF DESCRIPTION OF THE DRAWINGS

FIG. 1 is a front view of an exemplary label according to various embodiments.

FIG. 2 is a back view of an exemplary label according to various embodiments.

FIG. 3 is a front view of an exemplary label according to various embodiments.

FIG. 4 is a back view of an exemplary label according to various embodiments.

FIG. 5A illustrates a leading edge of an exemplary label affixed to a container according to various embodiments.

FIG. 5B illustrates an exemplary label secured about a container according to various embodiments.

FIG. 6 illustrates an exemplary label secured about a container according to various embodiments.

FIG. 7 illustrates an exemplary base label secured about a container according to various embodiments.

FIG. 8 illustrates a leading edge of an exemplary top label affixed to an exemplary base label according to various embodiments.

FIG. 9 illustrates an exemplary top label affixed to an exemplary base label and partially wrapped about a container according to various embodiments.

FIG. 10 illustrates an exemplary top label with a window affixed to an exemplary base label and partially wrapped about a container according to various embodiments.

FIG. 11 illustrates an exemplary top label with a window secured about a container and a portion of a base label visible through the window according to various embodiments.

FIG. 12 is a front view of a base label according to various embodiments.

FIG. 13 is a front view of a top label according to various embodiments.

FIG. 14 illustrates an exemplary base label secured about a container according to various embodiments.

FIG. 15A illustrates an exemplary base label and top label secured about a container according to various embodiments.

FIG. 15B illustrates an exemplary base label and top label secured about a container according to various embodiments.

FIG. 15C illustrates an exemplary base label and top label secured about a container according to various embodiments

FIG. 16 is a front view of a base label according to various embodiments.

FIG. 17 is a front view of a top label according to various embodiments.

FIG. 18 illustrates an exemplary base label and top label secured about a container according to various embodiments.

FIG. 19 is a front view of a base label according to various embodiments.

FIG. 20 is a front view of a top label according to various embodiments.

FIG. 21 illustrates an exemplary base label and top label secured about a container according to various embodiments.

FIG. 22 illustrates an exemplary base label and top label secured about a container according to various embodiments.

FIG. 23 illustrates an exemplary base label and top label secured about a container according to various embodiments.

FIG. 24 is an exemplary flow diagram of a method for measuring material dispensed from a container according to various embodiments.

### DETAILED DESCRIPTION

The present application is directed to illustrative rotating label measurement systems for a container. An exemplary illustrative label measurement system may comprise a base label adhered to the container. The base label may have a back surface and a front surface, with measurement information and gradient lines associated with the measurement information printed on the front surface. The label measurement system may further comprise a top label covering at least a portion of the front surface of the base label. The top label may be rotatable about the base label. In various embodiments, the top label may have a transparent window allowing at least a portion of the printed measurement information to be displayed through the transparent window. Rotation of the top label may cause the transparent window to display measurement information for a specific unit of measurement. Various embodiments may comprise a second transparent window to display the gradient line associated with the specific unit of measurement displayed in the transparent window.

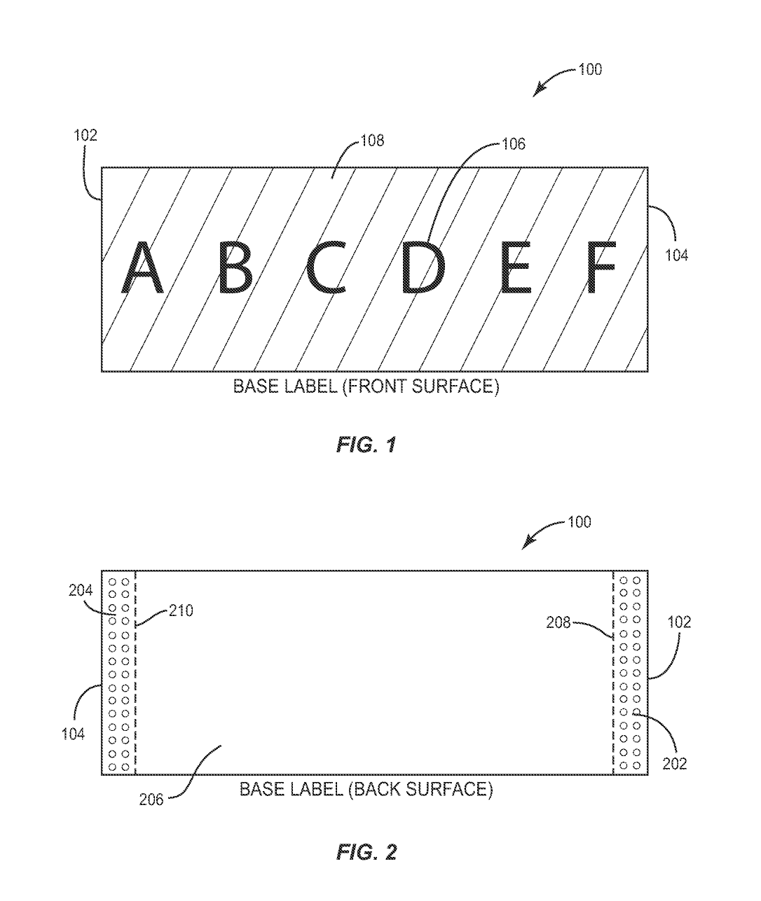

FIG. 1 illustrates various embodiments of a front surface 108 of a base label 100 for an object, such as a medication container, according to various embodiments. The base label 100 comprises a leading edge 102 and a trailing edge 104. While the leading edge 102 is oriented to the left and the trailing edge is oriented to the right as presented in FIG. 1, the orientation of the leading edge 102 and the trailing edge 104 could be reversed depending on which edge is first applied to the object. Both orientations are within the scope of the present disclosure. Base label front surface 108 may comprise writing or other indicia 106 thereon.

As used herein, the leading edge refers to the first edge to be affixed to the object and the trailing edge refers to the second edge to be affixed to the object or the overlapping leading edge. Depending on the orientation of the label and the object when the label is affixed to the object, either edge of the label may be the leading edge. The orientations presented in the figures are for convenience and are not intended to be limiting in any way.

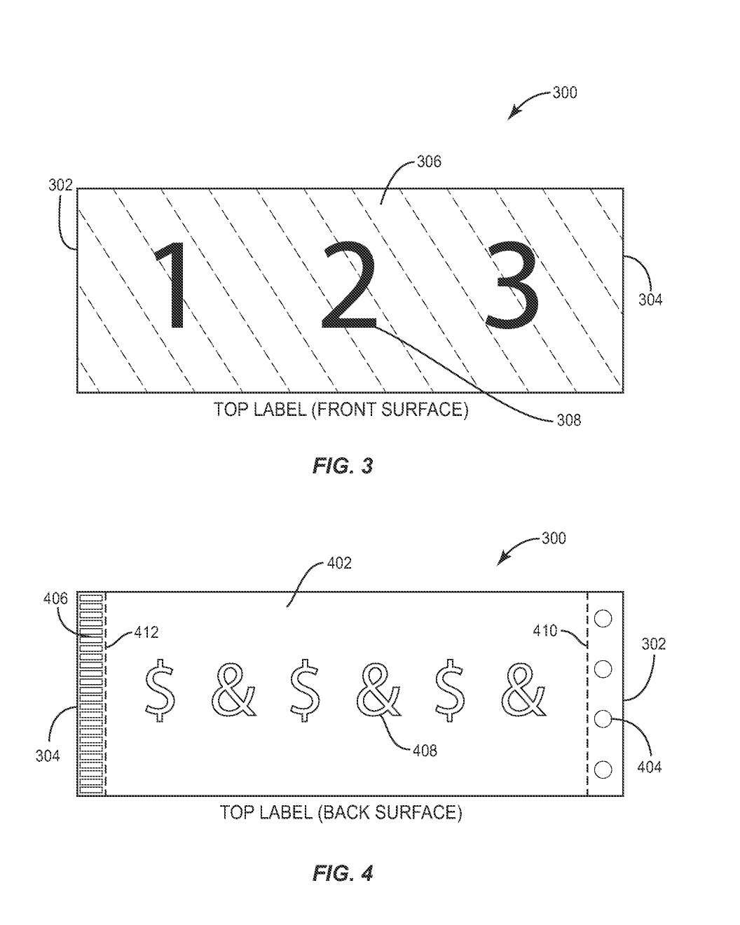

FIG. 2 illustrates various embodiments of a back surface 206 of the base label 100. In various embodiments, the base label back surface 206 comprises two strips of adhesive 202 and 204 on or immediately adjacent to the leading and trailing edges, 102 and 104, respectively. Base label leading edge adhesive 202 may have a boundary 208 defined as its limit on the base label back surface 206. Base label trailing edge adhesive 204 may also have a boundary 210. While FIG. 2 illustrates that the adhesive strips 202 and 204 are generally close to the base label leading and trailing edges 102 and 104, respectively, it is understood that the adhesive strips 202 and 204 may be continuous or discontinuous, and may extend across any portion of the base label back surface 206, including the entire base label back surface 206. In various embodiments, a length of the base label 100 may be selected to be slightly longer than a circumference of the object on which it is placed, such that the trailing edge 104 overlaps the leading edge 102, and the trailing edge 104 is affixed to the leading edge 102. In various embodiments, the length of the base label 100 may be selected to be approximately the same as the circumference of the object on which it is placed, such that the leading edge 102 and the trailing edge 104 do not overlap.

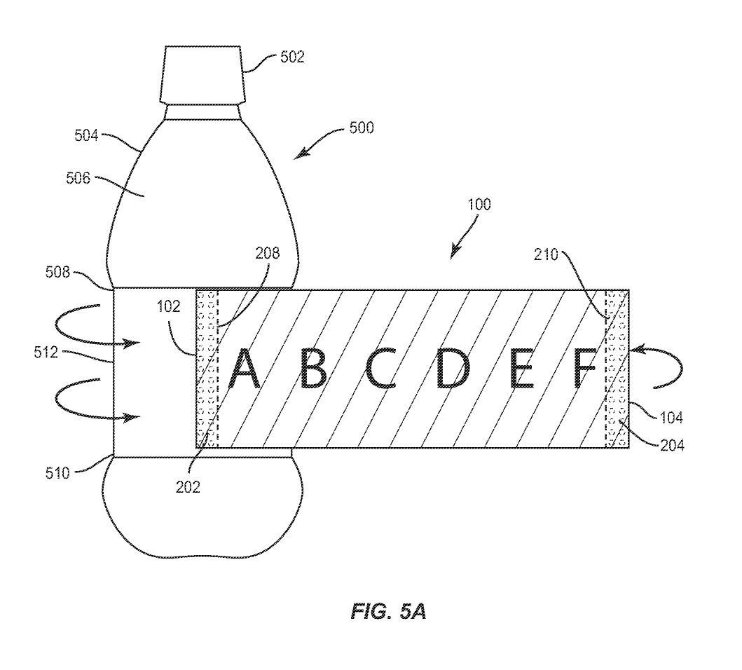

FIG. 3 illustrates various embodiments of a front surface 306 of a top label 300. Top label 300 comprises a leading edge 302 and a trailing edge 304, and indicia 308 may be imprinted on the top label front surface 306.

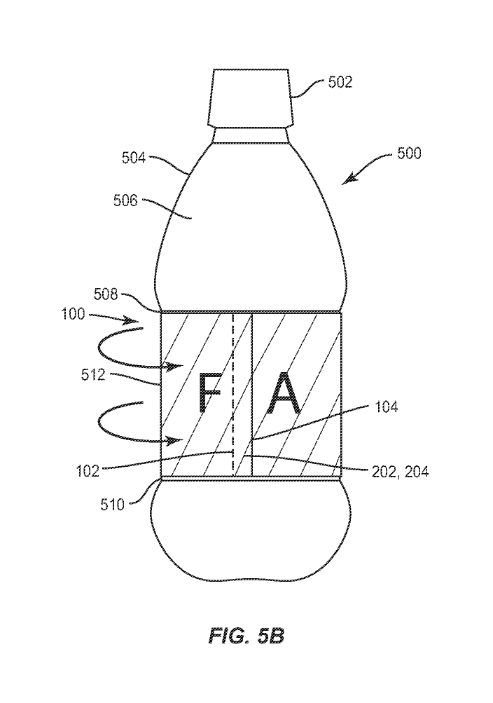

Various embodiments of a back surface 402 of the top label 300 are illustrated in FIG. 4. The top label back surface 402 may comprise various indicia 408 printed thereon, as well as two strips of adhesive 404 and 406 on or immediately adjacent to the leading and trailing edges, 302 and 304, respectively. Top label leading edge adhesive 404 may have a boundary 410 defined as its limit on the top label back surface 402. Top label trailing edge adhesive 406 may also have a boundary 412. While FIG. 4 illustrates that the adhesive strips 404 and 406 are generally close to the top label leading and trailing edges 302 and 304, respectively, it is understood that the adhesive strips 404 and 406 may be continuous or discontinuous, and may extend across any portion of the top label back surface 402, including the entire top label back surface 402. In various embodiments, the adhesive strips 404 and 406 are confined to areas near the leading and trailing edges 302 and 304, respectively, so as not to obscure or interfere with the top label back surface indicia 408.

The base label adhesive 202, 204 and the top label adhesive 404, 406 may be applied in a variety of patterns as can be appreciated by one skilled in the art. The adhesive 202, 204, 404, 406 may be applied in in strips, dots, droplets, circles, rectangles, squares, triangles, lines, and the like, as well as combinations of patterns.

A length of the top label 300 may be selected to be slightly longer than a circumference of the object on which it is placed, such that the top label trailing edge 304 overlaps the top label leading edge 302, and the top label trailing edge 304 is affixed to the top label leading edge 302. In various embodiments, the length of the top label 300 may be selected to be approximately the same as the circumference of the object on which it is placed, such that both the leading edge 302 and the trailing edge 304 do not overlap and are affixed to the base label front surface 108.

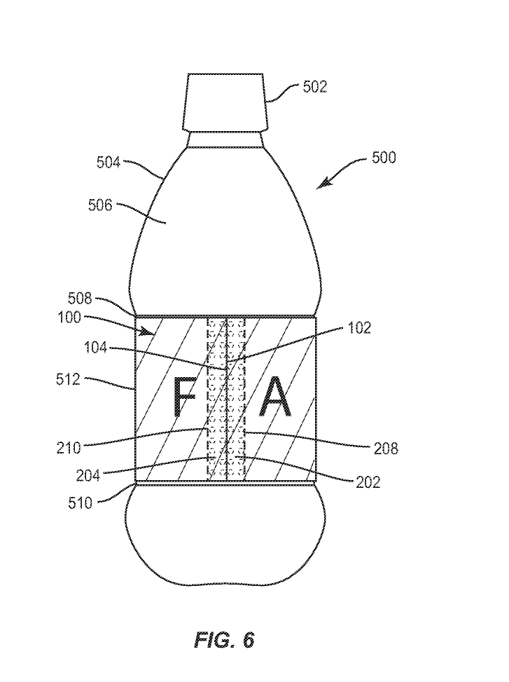

FIG. 5A illustrates the application of the base label 100 to an exemplary container 500 according to various embodiments. The container 500 may be a glass or plastic bottle, or other type of container such as a metal can or a cardboard receptacle. The container may be round, rectangular, square, or any other shape known in the art. The term “container” is used here for convenience to describe exemplary embodiments. It is understood that the container may be any object, including non-containers. Container 500 may comprise a cap 502 removably secured to a body 504. Various embodiments of the body 504 may have an exterior surface 506 that comprises a upper label panel 508, a lower label panel 510, and a recessed surface 512 interposed between the upper label panel 508 and the lower label panel 510. As discussed below, the base label 100 may be applied to the container 500 at the recessed area 512 between the upper label panel 508 and the lower label panel 510.

In various embodiments, the top label 300 may be rotatable about the base label 100, as discussed below. In these embodiments, the upper label panel 508 and lower label panel 510 may function to restrict upward and downward movement of the top label 300 in relation to the container 500 such that the top label 300 generally remains in a position covering at least a portion of the base label 100.

FIG. 5B illustrates the container 500 with the base label 100 affixed to the container 500. Initially, as illustrated in FIG. 5A, base label leading edge 102 is placed in contact with the recessed surface 512 of the container 500 and affixed to the container 500 by the leading edge adhesive strip 202. With relative motion between the container 500 and the base label 100, the base label 100 may be wrapped around the container 500 with the base label trailing edge 104 now overlapping the base label leading edge 102 such that the leading edge adhesive strip 202 holds the base label leading edge 102 to the container 500 while the trailing edge adhesive strip 204 holds the base label trailing edge 104 to the overlapped base label leading edge 102.

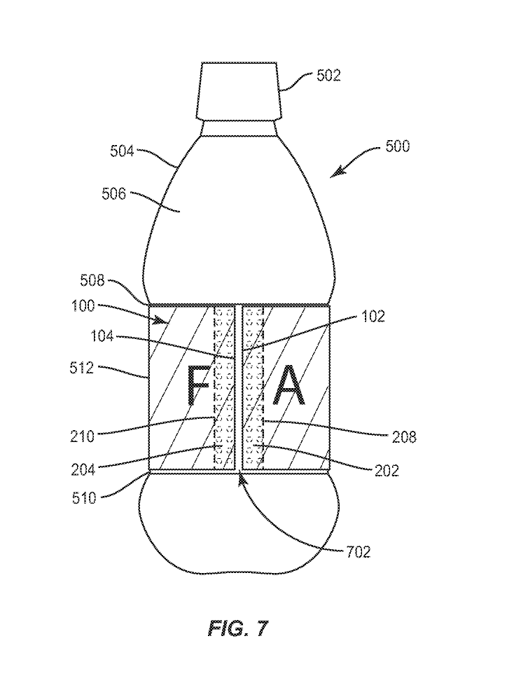

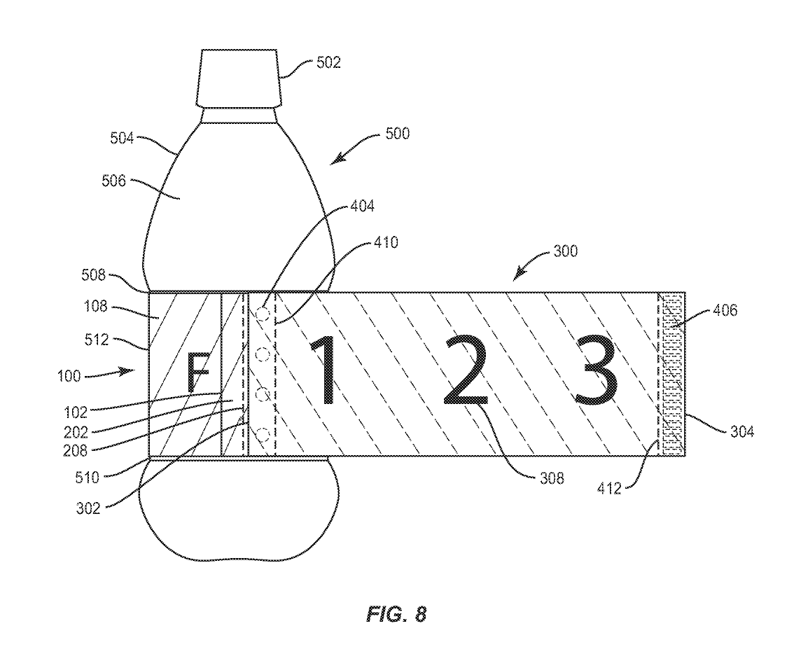

In various embodiments as illustrated in FIG. 6, the length of the base label 100 may be substantially the same as a circumference of the recessed surface 512 of the container 500, which may allow the base label leading edge 102 and base label trailing edge 104 to abut rather than overlap. However, it is also possible that the length of the base label 100 may be shorter than the circumference of the recessed surface 512, resulting in a gap 702 between the base label leading edge 102 and the base label trailing edge 104 when the base label 100 is affixed to the recessed surface as illustrated in FIG. 7. In both of these instances, the base label trailing edge adhesive strip 204 may adhere to the recessed surface 512 of the container 500, rather than the base label leading edge 102.

In various embodiments, the base label adhesive strips 202, 204 may comprise a permanent adhesive. In general, a permanent adhesive is one that does not readily release from a surface to which it adheres after the adhesive dries or cures. Using the base label 100 as an example, the permanent adhesive 202, 204 will tend not to release from the recessed surface 512, nor will it tend to release the base label leading edge 102 or trailing edge 104 once dried or cured. In order to remove the base label from the recessed surface 512, the base label 100 may have to be torn from the adhesive, or the adhesive layer 202, 204 may have to be fractured which may leave some of the adhesive on the recessed surface 512 and some of the adhesive on the base label leading edge 102 or trailing edge 104. Once the surfaces affixed with the permanent adhesive are separated, they may not be reattached.

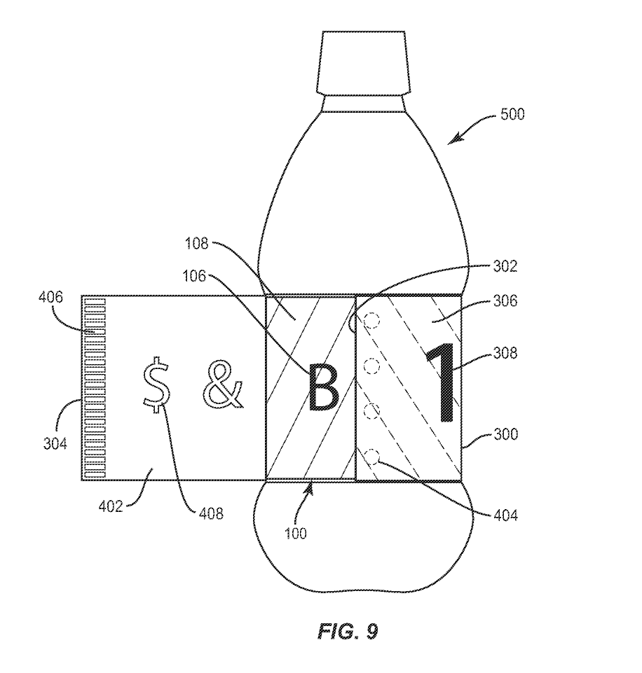

In FIG. 8, the base label 100 is already affixed to the recessed surface 512 of the container 500, and the application of the top label 300 over the base label 100 is illustrated according to various embodiments. The top label leading edge 302 may be placed in contact with any portion of the base label front surface 108 and affixed to the base label front surface 108 by the top label leading edge adhesive strip 404. With relative motion between the container 500 and the top label 300, the top label 300 may be wrapped around the container 500 with the top label trailing edge 304 now overlapping the top label leading edge 302 such that the top label leading edge adhesive strip 404 holds the top label leading edge 302 to the base label 100 while the top label trailing edge adhesive strip 406 holds the top label trailing edge 304 to the overlapped top label leading edge 302.

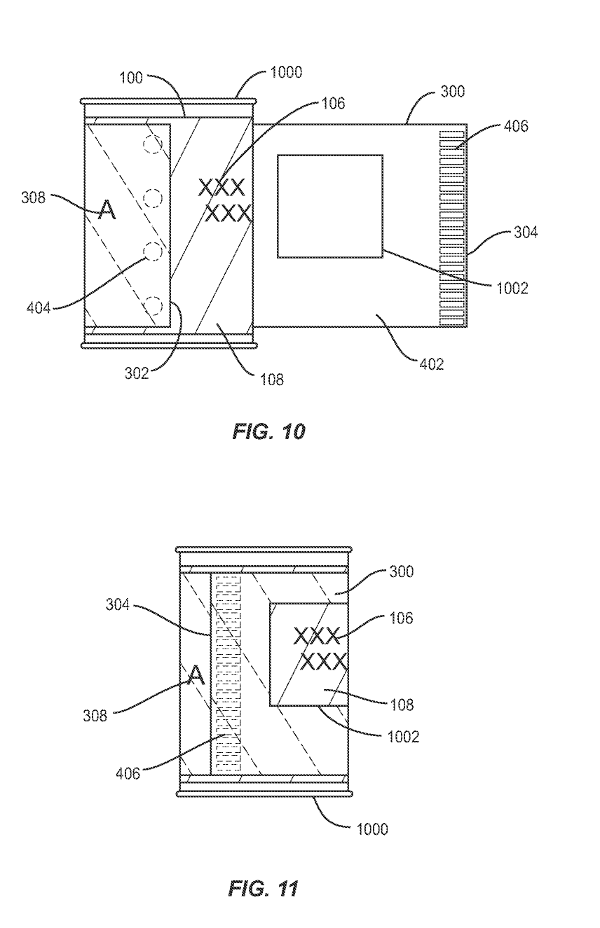

FIG. 9 illustrates the operation of the base label 100 and the top label 300 according to various embodiments. Beginning with the container 500 with the base label 100 and the top label 300 in place as shown, for example, in FIG. 6, the top label trailing edge 304 may be detached from the top label leading edge 302 and at least partially peeled back as shown in FIG. 9. The combination of the base label 100 and the top label 300 in this configuration increases the amount of surface area available for viewing by a consumer or user of the container 500. Prior to detaching the top label trailing edge 304, the consumer may view the top label front surface 306. Upon detaching the top label trailing edge 304, the consumer may now view the top label back surface 402 and the base label front surface 108 in addition to the top label front surface 306.

One of at least three types of adhesive may be used for the top label leading edge adhesive 404. A first type of adhesive is the permanent adhesive as described above for the base label 100. When a permanent adhesive is used for the top label leading edge adhesive 404, the top label leading edge generally cannot be detached without inflicting damage to one or both of the top label 300 or the base label 100. This may be desirable for various embodiments where the top label 300 is not intended to be removed from the container 500.

A second type of adhesive that may be used for the top label leading edge adhesive 404 is a releasable adhesive. A releasable adhesive is one that will release from a surface to which it is attached once a sufficient mechanical force is applied. A releasable adhesive may be used, for example, when the top label back surface 402 comprises a coupon for a subsequent purchase of a product. The releasable adhesive may allow the consumer to easily remove the top label 300 for later use. In various embodiments, the releasable adhesive may be a breakaway adhesive. A breakaway adhesive may have limited ability to withstand shear stresses. Shear stresses may cause the adhesive bond created between the label (e.g., top label 300) and the surface to which it is affixed (e.g., the base label 100 or container 500) to fail along the adhesive. In general, a releasable or breakaway adhesive may not re-attach to a surface once removed.

A third type of adhesive that may be used for the top label leading edge adhesive 404 is a resealable adhesive. A resealable adhesive may release from a surface to which it is attached once a sufficient mechanical force is applied, similar to the releasable adhesive described above. However, the resealable adhesive may be re-attached to a surface by applying pressure. A resealable adhesive may be desirable when the top label back surface 402 or the base label front surface 108 comprise information that may be needed only on occasion. Thus, the consumer or user may detach the top label 300 when the information is needed, then re-attach the top label 300.

In various embodiments, the top label trailing edge adhesive 406 may be a releasable adhesive or a resealable adhesive, depending on the intended use of the top label 300. As described above, if the surfaces 108, 402 comprise information that is intended to stay with the container, the top label trailing edge adhesive 406 may be a resealable adhesive. In contrast, if the top label 300 is intended to be removed from the container 500, a releasable adhesive may be desirable.

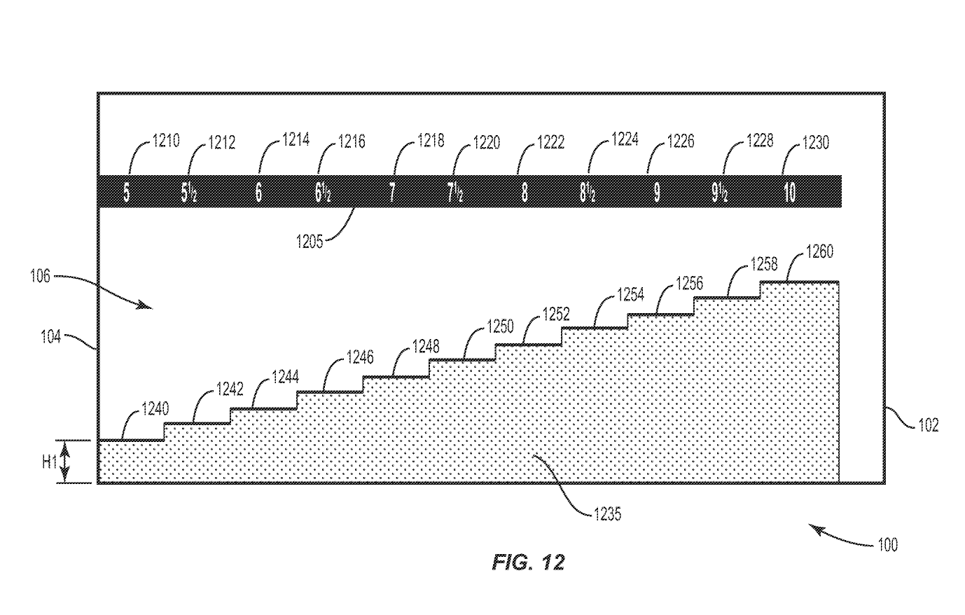

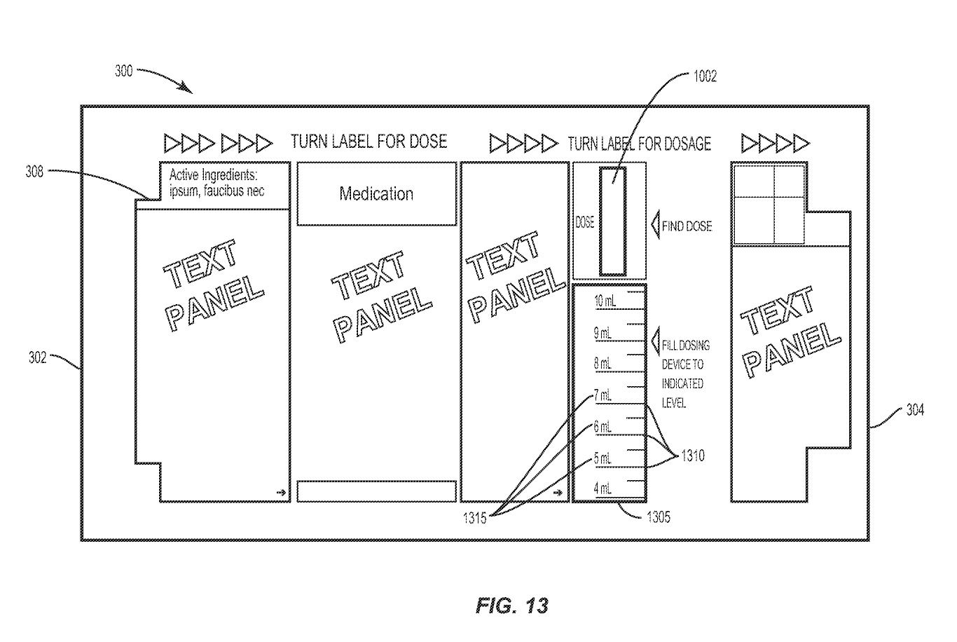

FIG. 10 illustrates various embodiments of the top label 300 comprising a window 1002. The window 1002 may comprise a void in the top label 300 such that a portion of the base label 100 may be visible through the window. In various embodiments, the window 1002 may have a transparent covering (not shown). In various other embodiments, the window may comprise a transparent section of the top label 300 itself rather than a void. FIG. 10 illustrates the top label 300 partially wrapped about a container 1000, and base label 100 already in place on the container 1000. As shown, the top label leading edge adhesive 404 maintains the top label 300 coupled to the base label 100. The top label 300 may then be moved from the position illustrated in FIG. 10 to the position illustrated in FIG. 11 to secure the top label 300 about the container 1000. Top label trailing edge adhesive 406 may couple to the top label leading edge 302 if the top label leading edge 302 and trailing edge 304 overlap; otherwise, the top label trailing edge adhesive 406 may be coupled to the base label front surface 108.

Once the top label 300 is in position on the container 1000 as illustrated in FIG. 11, at least a portion of the base label front surface indicia 106 may be visible through the window 1002. This may allow viewing of a first portion of the base label 100 without removing the top label 300. In various embodiments, the top label leading edge adhesive 404 may be a breakaway adhesive. Rotation of the top label 300 relative to the base label 100 may exert shear stresses on the breakaway adhesive, causing the adhesive bond affixing the top label leading edge 302 to the base label 100 to fail. The top label 300 may then be freely rotatable about the base label 100, and a second portion of the base label 100 may be visible when the top label 300 is rotated to a second position. The window 1002 may be rectangular as illustrated in FIGS. 10 and 11, or any other shape as needed for a particular application. For example, the window 1002 may be a slit that reveals an alphanumeric string on the base label 100. In various embodiments, the top label 300 may comprise more than one window 1002. Various embodiments in which the top label trailing edge adhesive 406 is a resealable or releasable adhesive may allow the top label 300 to be peeled back to reveal the top label back surface 402 and essentially the entire base label front surface 108 or to be removed from the container 1000, in addition to being rotatable.

One skilled in the art will readily recognize that labels may be applied to containers using a variety of methods and that there may be a variety of single-label and multi-label systems other than those described above. Any such application methods or label systems may be used with the present disclosure. The above descriptions are exemplary and not to be construed as limiting in any way. Examples of other application methods and label systems may be disclosed in U.S. Pat. Nos. 5,884,421, 6,086,697, 6,237,269, 6,402,872, 6,631,578, 6,649,007, 7,087,298, and 7,172,668.

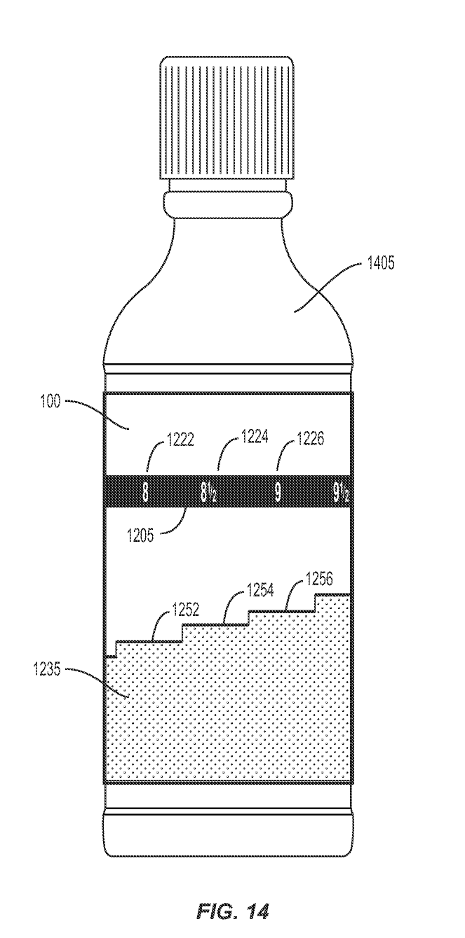

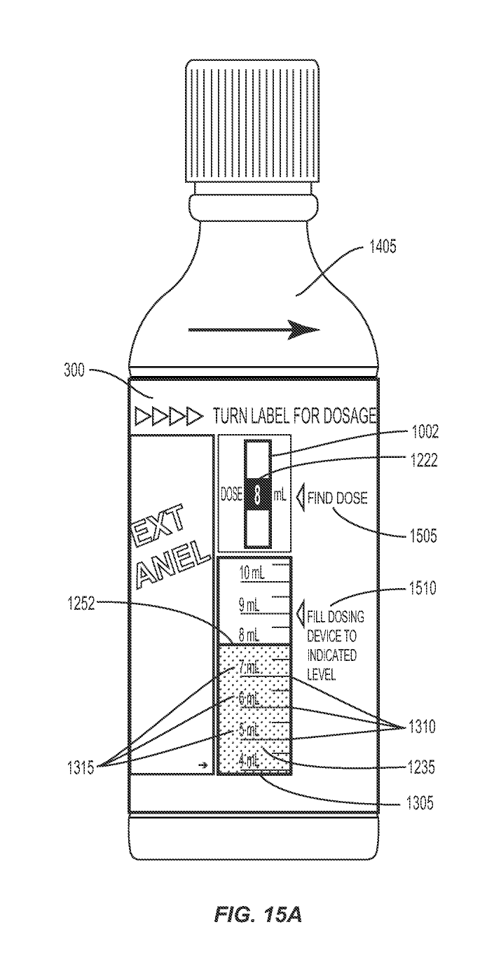

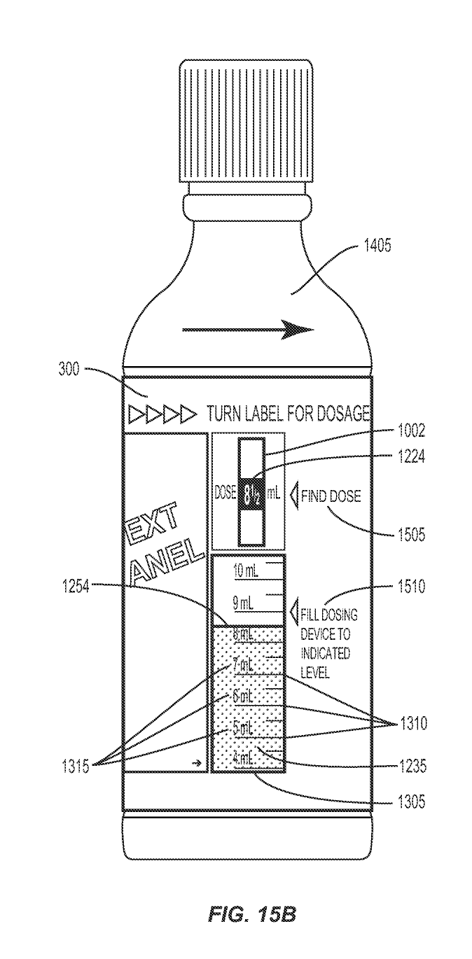

FIGS. 12 and 13 illustrate a base label 100 and top label 300, respectively, that may comprise an illustrative label measurement system for a container, such as a medication container 1405 (see FIG. 14) according to various embodiments. The base label indicia 106 may comprise printed measurement information in numerical form 1205 or graphical form 1235. Although both the numerical form 1205 and graphical form 1235 of the measurement information are shown in FIG. 12, various embodiments may include one of the numerical form 1205 or graphical form 1235.

The numerical form 1205 of the measurement information may comprise a plurality of individual numerical amounts of a dose 1210-1230 corresponding to a specific unit of measurement. In various embodiments, the numerical amounts of a dose 1210-1230 may indicate progressively larger doses in equal increments (as illustrated in FIG. 12), or may vary in another manner, such as according to a geometric progression, arithmetic progression, harmonic progression, logarithmic function, or the like.

The graphical form 1235 of the measurement information may comprise a plurality of gradient lines 1240-1260, each having a height H1 measured from a reference point, such as an edge of the base label 102. In various embodiments, the height H1 of each gradient line 1240-1260 may vary in a manner similar to the variation between the numerical amounts of a dose 1210-1230 (such as linear, geometric, arithmetic, etc.). The numerical amounts of a dose 1210-1230 and the gradient lines 1240-1260 may be positioned on the base label 100 such that one or more numerical amounts of a dose 1210-1230 are aligned with one or more gradient lines 1240-1260. For example, the embodiments of FIG. 12 illustrate a vertical alignment between the numerical amounts of a dose 1210-1230 and the gradient lines 1240-1260. In this example, numerical amount of a dose 1210 is aligned with gradient line 1240, numerical amount of a dose 1212 is aligned with gradient line 1242, and so on. In various embodiments, the alignment between the numerical amounts of a dose 1210-1230 and the gradient lines 1240-1260 may be horizontal, diagonal, helical, or any other alignment known in the art.

As illustrated in FIG. 13, various embodiments of the top label 300 may comprise indicia 308 relaying product-related information, safety-related information, manufacturer-related information, and the like. In various embodiments, the top label 300 may contain a transparent window 1002 as described previously (see FIG. 10). The top label 300 may also contain a second transparent window 1305. The second transparent window 1305 may comprise opaque markings thereon. The opaque markings may comprise a series of scale lines 1310 that divide the second transparent window 1305 into dose amounts or portions of dose amounts. In the embodiments illustrated in FIG. 13, the scale lines 1310 indicate dose amounts of milliliters (mL) and half milliliters between each milliliter scale line 1310. Corresponding to at least a portion of the scale lines 1310, the opaque markings may further comprise numerical indicia 1315 corresponding to the scale lines 1310. As shown in FIG. 13, the numerical indicia 1315 indicate each milliliter of volume (i.e., 4 mL, 5 mL, 6 mL, 7 mL, etc.). One skilled in the art will readily recognize that any unit of measurement (e.g., milliliters, ounces, teaspoons, tablespoons, etc.) may be used in various embodiments, and the scale lines 1310 may indicate any whole number (e.g., 1, 2, 3, etc.) of units or partial units (e.g., ½, ⅓, ¼, etc.).

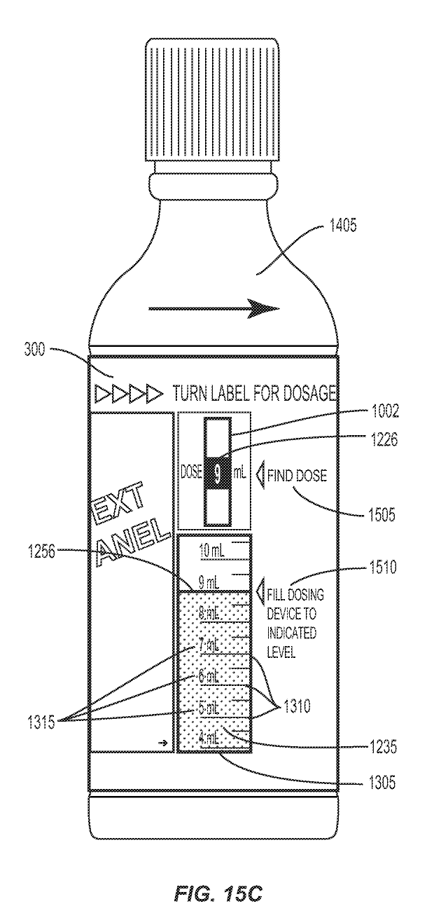

FIG. 14 illustrates the base label 100 positioned on the container 1405 according to various embodiments. As discussed above, the base label 100 may comprise printed measurement information in numerical form 1205 and graphical form 1235 printed on the front surface such that the measurement information 1205, 1235 at least partially encircle the container 1405. FIGS. 15A through 15C illustrate the top label 300 in place over the base label 100 on the container 1405 according to various embodiments. The base label 100 and the top label 300 may comprise an illustrative label measurement system that may be used, for example, on a medication container 1405 to provide additional functionality that may illustrate a dosage in a variety of formats (such as numerical and graphical) to foster better understanding of the proper dose. Providing such dosage information may be advantageous to a consumer unfamiliar with how to dispense the medication, is not literate in the language of the label system, or may be visually impaired.

FIG. 15A illustrates the top label 300 in place over the base label 100. As described previously, the top label 300 may be applied such that the top label 300 is rotatable around a circumference of the container 1405. In FIG. 15A, the top label 300 has been rotated in the direction of the arrow revealing at least one of the numerical amounts of a dose 1210-1230 (in this example, numerical amount 1222 corresponding to 8 mL) through the transparent window 1002 in the top label 300. Simultaneously, at least one of the gradient lines 1240-1260 (in this example, gradient line 1252 which as illustrated in FIG. 12 corresponds to numerical amount of a dose 1222) may be revealed in the second transparent window 1305. The height H1 of the gradient line 1252 may be selected to position the gradient line 1252 at the scale line 1310 and numerical indicia 1315 identical to the numerical amount of a dose 1222 visible in the transparent window 1002. In this example, the gradient line 1252 is positioned at the scale line 1310 and numerical indicia 1315 at 8 mL, which is the same numerical amount of a dose 1222 visible in the transparent window 1002. In various embodiments, the portion of the graphical form 1235 of the measurement information area visible through the second transparent window 1305 may be shaded to facilitate visual identification of the proper dose.

In various embodiments, the top label 300 may include instructions to aid the consumer in the use and interpretation of numerical amount of a dose 1210-1230 visible in the transparent window 1002 and the gradient lines 1240-1260 visible in the second transparent window 1305. For example, the top label 300 in FIG. 15A may comprise first instruction 1505 associated with the numerical representation of the dosage 1275, such as “Find Dose” or other similar instruction. The first instruction 1505 instructs the consumer to find the dose corresponding to the numerical amount of a dose 1222 (in this case, 8) on a second container (e.g., a measuring device) and fill the second container to the level indicated by the gradient line 1252 as illustrated in the second transparent window 1305. Various embodiments of the top label 300 may also comprise a second instruction 1510 to facilitate the use of the gradient lines 1252, the scale lines 1310, and the numerical indicia 1315. For example, the top label 300 in FIG. 15A may comprise second instruction 1510 such as “Fill Dosing Device to Indicated Level” or other similar instruction. The second instruction 1510 may instruct the consumer to fill the second container until it approximately matches the gradient line 1252.

Similarly, FIGS. 15B and 15C illustrate the top label 300 further rotated in the direction of the arrow, thus revealing a different one of the numerical amount of a dose 1210-1230 through the transparent window 1002 and a different one of the gradient lines 1240-1260 through the second transparent window 1305. In the example of FIG. 15B, the top label 300 has been rotated until the numerical amount of a dose 1224 for 8½ mL is displayed in the transparent window 1002. In addition, gradient line 1254 is now visible through the second transparent window 1305 and is positioned at the scale line 1310 corresponding to 8½ mL. Similarly, FIG. 15C illustrates the top label 300 rotated to indicate a dose of 9 mL. Although FIGS. 15A-15C illustrate a single numerical amount of a dose 1210-1230 visible through the transparent window 1002 and a single gradient line 1240-1260 visible through the second transparent window 1305, two or more numerical amounts of a dose 1210-1230 and gradient lines 1240-1260 may simultaneously be visible through the transparent window 1002 and second transparent window 1305, respectively, in various embodiments.

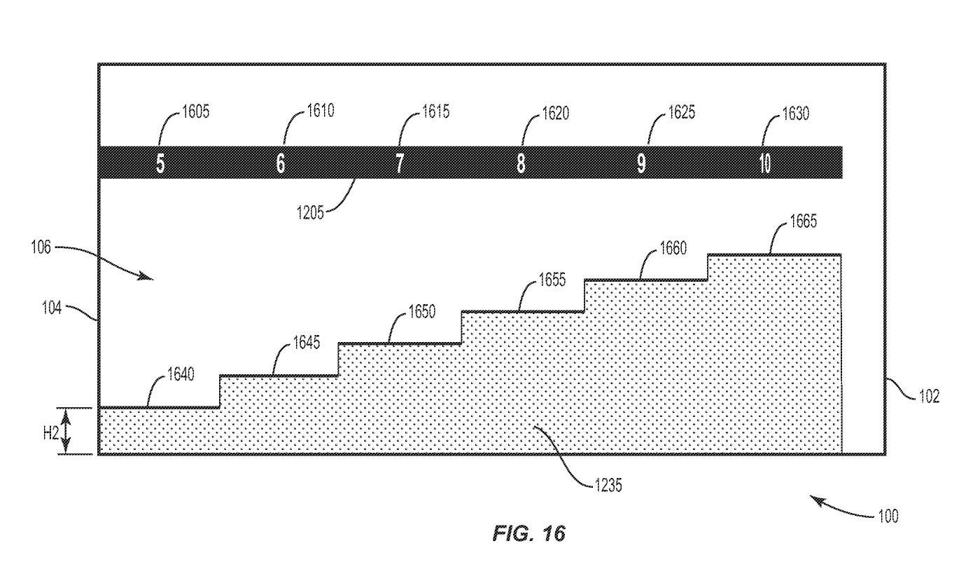

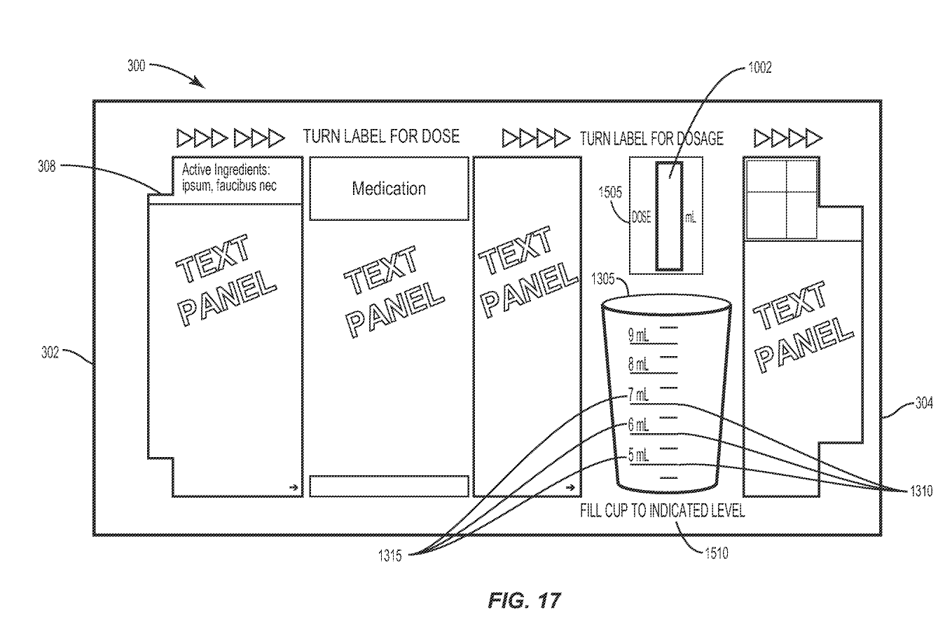

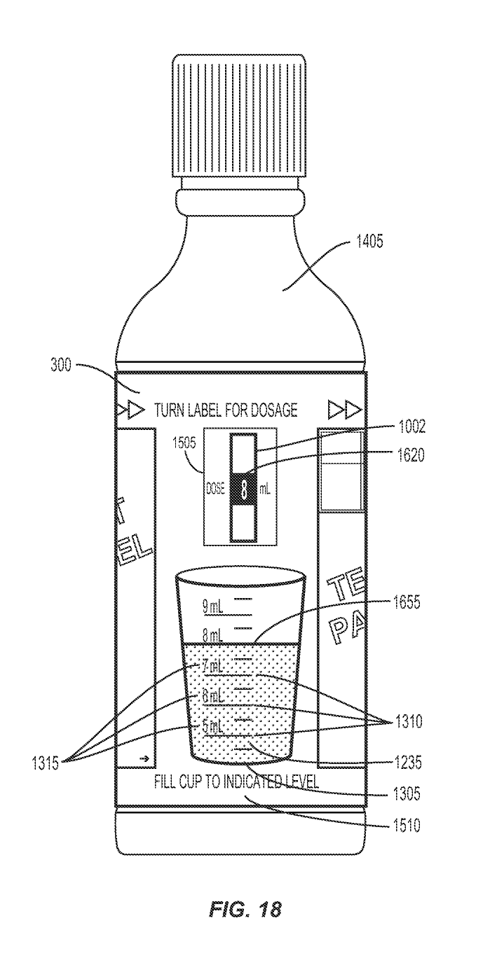

The second transparent window 1305 as illustrated in FIGS. 15A through 15C and the opaque markings 1310, 1315 depict a generic measuring device. However, the second transparent window 1305 may be shaped to more closely correspond to a specific measuring device to more readily illustrate the proper dose. For example, FIGS. 16 through 18 illustrate various embodiments in which the second transparent window 1305 is shaped similar to a measuring cup. As described previously, the base label 100 may comprise a numerical form 1205 of the measurement information and a graphical form 1235 of the measurement information. The numerical form 1205 of the measurement information may comprise a plurality of numerical amounts of a dosage 1605-1630, and the graphical form 1235 of the measurement information may comprise a plurality of gradient lines 1640-1665. Each gradient line 1640-1665 may have an individual height H2. FIG. 17 illustrates the second transparent window 1305 in the shape of a measuring cup, and the second transparent window 1305 may further comprise opaque markings 1310, 1315 as described previously. FIG. 18 illustrates both the base label 100 and the top label 300 positioned on the container 1405, indicating a dose of 8 mL in numeric form in the first transparent window 1002 and graphical form in the second transparent window 1305. The consumer may more readily visualize the proper level to fill the measuring cup using the various embodiments illustrated in FIG. 18. One skilled in the art will recognize that the second transparent window 1305 may illustrate any measuring device known in the art, such as a measurement spoon, measurement cup, spray dispenser, inhaler, dropper, and the like.

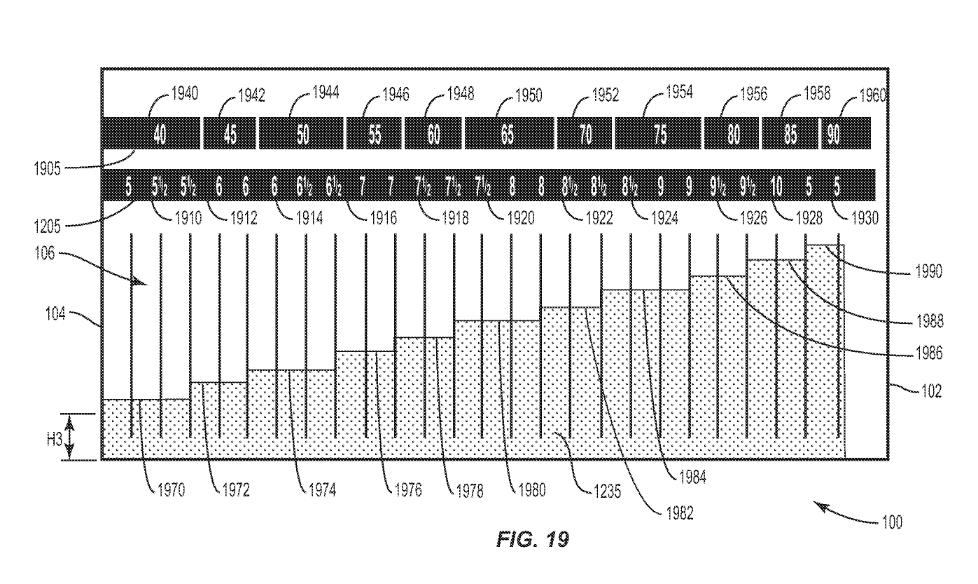

The proper dosage of certain medications may depend on the weight of the consumer, particularly when the consumer is a child. FIG. 19 illustrates various embodiments of a base label 100 adapted for determining dosage based on the weight of the consumer. As described previously, the base label comprises a plurality of numerical amounts of a dose 1910-1930 and a plurality of corresponding gradient lines 1970-1990. Each gradient line 1970-1990 may have an individual height H3. In various embodiments, the base label 100 may further comprise numerical weight information 1905 comprising individual weight values 1940-1960. Each individual weight value 1940-1960 may correspond to one or more numerical amounts of a dose 1910-1930.

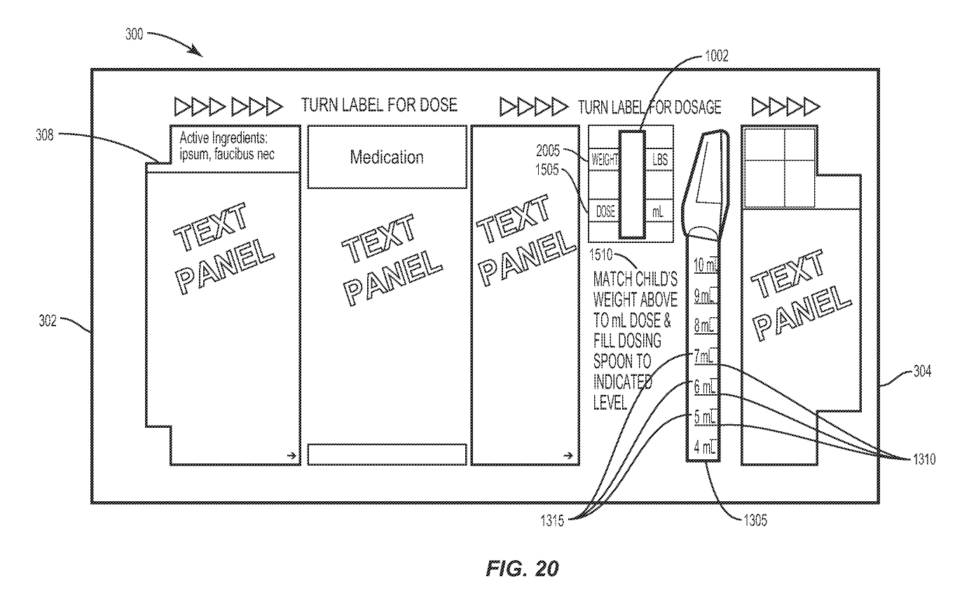

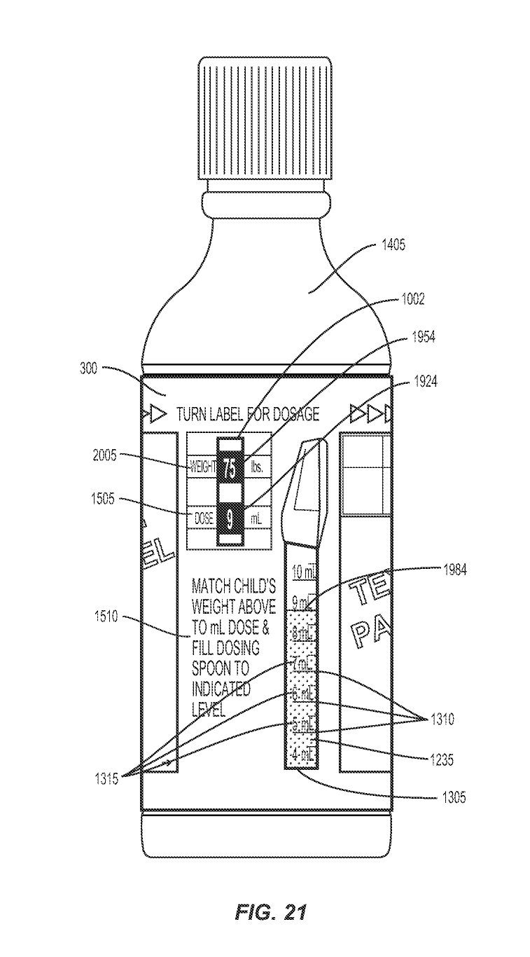

FIG. 20 illustrates a top label 300 for use with the base label 100 of FIG. 19 according to various embodiments. The transparent window 1002 may be sized to display one or more of the numerical amounts of a dose 1910-1930 and one or more of the individual weight values 1940-1960. Alternatively, the transparent window 1002 may be divided into two separate windows (not shown) to individually display the numerical amount of s dose 1910-1930 and the individual weight values 1940-1960. FIG. 21 illustrates various embodiments of the base label 100 of FIG. 19 and the top label 300 of FIG. 20 positioned on the container 1405. The transparent window 1002 may display the individual weight value 1954 and the numerical amount of the dose 1924 (in this example, 75 lbs. and 9 mL, respectively). The second transparent window 1305, illustrated in the shape of a measuring spoon, may display the gradient line 1984 corresponding to the 9 mL dose.

The top label 300 as illustrated in the various embodiments of FIGS. 20 and 21 may comprise first instruction 1505 to indicate the dose, second instruction 1510 instructing the consumer how to match a dose with the consumer's weight, and third instruction 2005 indicating the weight. The top label 300 may further comprise additional instructions for use of the illustrative label measurement system.

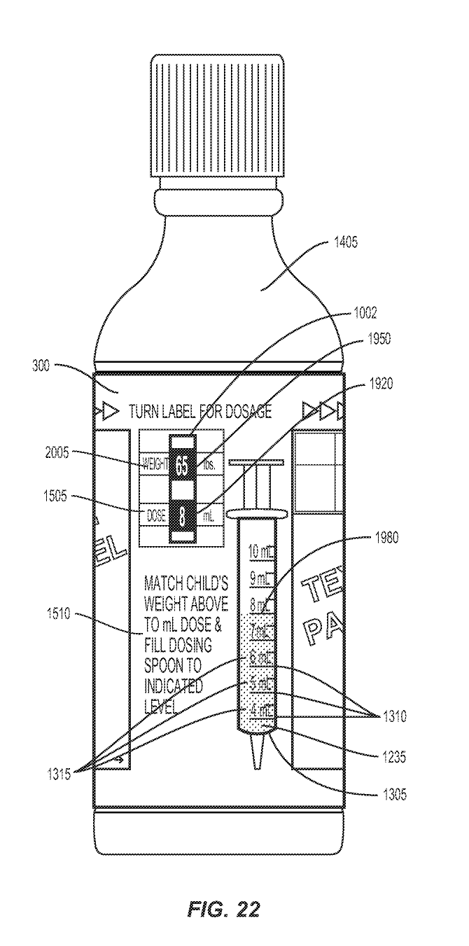

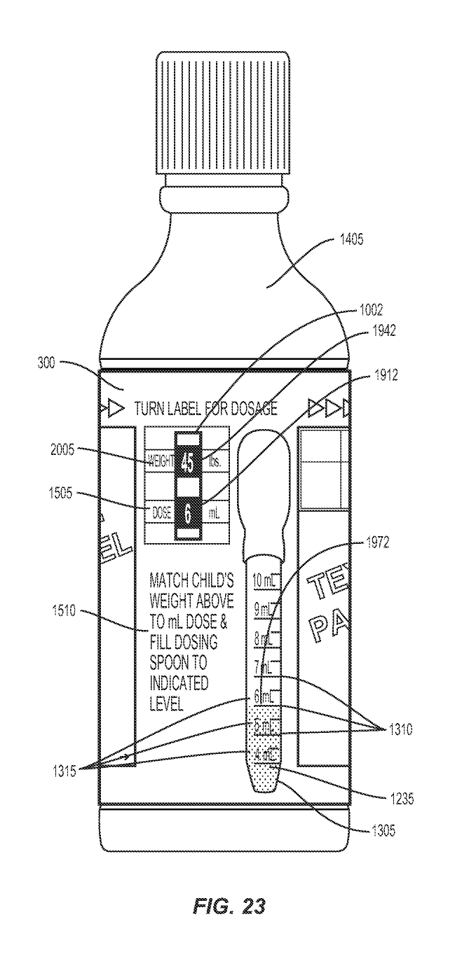

FIGS. 22 and 23 illustrate various embodiments in which the second transparent window 1305 may depict different types of measuring devices. For example, FIG. 22 depicts a measuring syringe and FIG. 23 depicts a measuring dropper.

Various embodiments may also be used to determine a proper dose based on consumer-related information other than weight. For example, the base label 100 may comprise a plurality of values related to height, age, blood pressure, body temperature, level of pain or other discomfort, level of energy, level of mobility, and the like. The plurality of consumer-related information values may be positioned on the base label 100 such that when the top label 300 is rotated to a position where the desired consumer-related information value is visible in one of the transparent windows 1002, 1305, the proper dose is also visible in one of the transparent windows 1002, 1305.

In various embodiments, the health care provider dispensing the medication may rotate the outer label 300 until the numerical form 1205 or the graphical form of the measurement information (or numerical weight information 1905) corresponding to the proper dose is visible through the transparent window 1002 and second transparent window 1305. The consumer may then simply look at the information displayed in the first transparent window 1002 or second transparent window 1305 and determine the correct dose, which may be accomplished in a number of ways without reading any instructions or even being able to read the instructions. In the exemplary situation where the prescribed dose is 8 mL, the outer label 300 may be rotated to the position shown in FIG. 15A. The consumer may observe that the gradient line 1252 is positioned at the scale line 1310 and numerical indicia 1310 at the 8 mL mark, and then fill the second container (e.g., the measuring spoon) to the 8 mL mark. Alternatively, the consumer may fill the second container until the amount of material in the second container is approximately the same as that indicated by the shaded area under the gradient line 1252. Finally, the consumer may observe the numerical representation of the dose 1275 and fill the second container to the matching number.

While FIGS. 12 through 23 illustrate various embodiments adapted for liquid medications, the illustrative label measurement system may also be adapted for use with solid medications such as pills, tablets, capsules, and the like. For example, the graphical form 1235 of the measurement information may depict pills, tablets, or capsules in the palm of a hand in the same way the consumer may shake pills, tablets, or capsules out of the container 1405 into their hand. Similarly, a nasal inhaler may also be used to dispense medications by spraying the medication one or more times from the inhaler. The graphical form 1235 of the measurement information may depict the number of sprays in each dose. For example, the graphical form 1235 of the measurement information may depict a single inhaler for a one-spray dose, two inhalers for a two-spray dose, and so on.

In addition to the dispensing of liquids or solids as described above, the label measurement system may be used with containers 1405 of mixtures of liquids and solids, such as solids dissolved in liquids and solids dispersed in a liquid.

The top label 300 may comprise a dual ply (or multi-ply) construction in which a ply in contact with the base label 100 is a material selected for low sliding friction characteristics. The low sliding friction characteristics may enhance the ease of rotating and sliding the top label 300 about the base label 100. In various embodiments, the top label 300 ply in contact with the base label 100 may be coated with a substance to impart the low sliding friction characteristics.

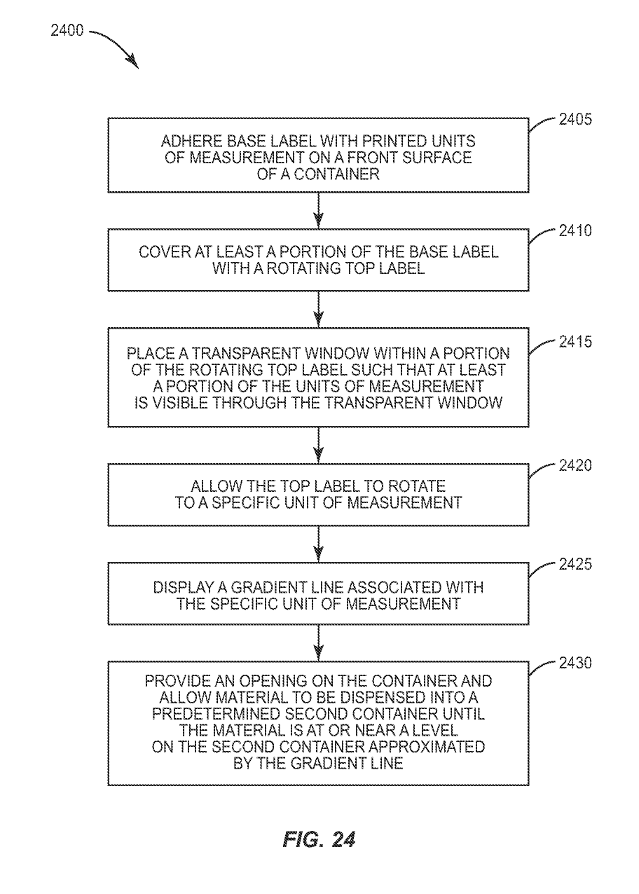

FIG. 24 illustrates a general flow chart of various embodiments of a method 2400 for measuring material dispensed from a container. A base label 100 may be applied to a container 1405 (step 2405). The base label 100 may have a back surface 206 and a front surface 108. A plurality of units of measurement may be printed on the front surface 108 of the base label 100. Referring, for example, to FIG. 12, the units of measurement may comprise specific units of measurement such as 5 mL, 5½ mL, 6 mL, etc., as depicted by numerical amounts of a dose 1210-1230, and gradient lines 1240-1260 corresponding to each of the specific numerical amounts of a dose 1210-1230. At step 2410, at least a portion of the base label 100 may be covered with a rotating top label 300. In various embodiments, the base label 100 may be coupled to the container 1405 while the top label 300 is free to rotate about the base label 100. A transparent window 1002 may be placed within a portion of the rotating top label 300 at step 2415 such that at least a portion of the numeric amounts of a dose 1210-1230 is visible through the transparent window 1002. A second transparent window 1305 may be placed within a portion of the rotating top label 300 such that at least a portion of the gradient lines 1240-1260 is visible through the second transparent window 1305. As the top label 100 is rotated about the base label 100, one or more of the other specific units of measurement depicted by the numeric amount of a dose 1210-1230 may alternately be visible through the transparent window 1002, and the corresponding gradient line 1240-1260 is visible through the second transparent window 1305. In various embodiments, more than one of the numeric amounts of a dose 1210-1230 may be visible through the transparent window 1002 and more than one of the gradient lines 1240-12160 may be visible through the second transparent window 1305. The top label 300 may be allowed to rotate at step 2420 to a specific numeric amount of a dose 1210-1230 that may correspond to a desired dose. When the top label 300 is rotated to the desired dose, a gradient line 1240-1260 associated with the specific numeric amount of a dose 1210-1230 may be displayed in second transparent window 1305 (step 2425). At step 2430, an opening may be provided in the container 1405 for dispensing material from the container 1405. The material may be dispensed from the container 1405 until an amount dispensed is at or near an amount approximated by the gradient line 1240-1260.

In various embodiments, all or a portion of the indicia 106 may be imprinted, embossed, or molded directly on an outer surface of the container 1405 in place of all or a portion of the base label 100. The imprinting or embossing may be carried out using any printing or image transfer method known in the art. In various embodiments, the printing or image transfer method may be an offset process in which an image is transferred from a plate to an intermediate carrier, then to the outer surface of the container 1405. The offset process may also involve lithographic techniques. Other printing or image transfer methods may comprise, for example, flexography, pad printing, relief printing, rotogravure, screen printing, and electrophotography. According to various embodiments, the indicia 106 may be digitally printed on the outer surface of the container 1405 using, for example, inkjet printing or laser printing. Chemical printing technologies, such as blueprint or diazo print may also be used in various embodiments.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising”, and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A rotating label measurement system for a container comprising:
a base label adhered to the container, the base label having a front surface with printed measurement information;
an opaque rotating top label covering at least a portion of the front surface of the base label;
a transparent window within a portion of the opaque rotating top label, the transparent window displaying at least a portion of the printed measurement information; and
wherein rotation of the opaque rotating top label causes the transparent window to display printed measurement information for a a specific unit of measurement.

2. The system of claim 1, wherein the printed measurement information includes a gradient line for the specific unit of measurement.

3. The system of claim 1, wherein the printed measurement information includes the specific unit of measurement.

4. The system of claim 1, wherein the specific unit of measurement includes a numeric amount of dose to be administered.

5. The system of claim 1, wherein the printed measurement information includes a patient weight.

6. The system of claim 5, wherein the patient weight includes a corresponding numeric amount of dose to be administered.

7. The system of claim 2, wherein the gradient line indicates a level of material dispensed from the container into a predetermined second container.

8. The system of claim 7, wherein the material is liquid, solid or any combination thereof.

9. The system of claim 7, wherein the predetermined second container is any of a cup, a syringe, a spoon, or a dropper.

10. The system of claim 1, further comprising a second transparent window within a portion of the opaque rotating top label.

11. The system of claim 10, wherein a gradient line corresponding to the specific unit of measurement is displayed in the second transparent window.

12. The system of claim 10, wherein the second transparent window comprises one or both of scale lines and numerical indicia of the specific unit of measurement thereon.

13. A rotating label measurement system for a container comprising:
a base label adhered to the container, the base label having a front surface with printed specific units of measurement and a gradient line associated with each specific unit of measurement, wherein a height of each gradient line is proportional to the associated specific unit of measurement;
an opaque rotating top label covering at least a portion of the front surface of the base label;
a transparent window within a portion of the opaque rotating top label, the transparent window displaying at least a portion of the specific units of measurement;
a second transparent window within a portion of the opaque rotating top label, the second transparent window displaying at least a portion of the gradient lines; and
wherein rotation of the opaque rotating top label causes the transparent window to display a specific unit of measurement and the second transparent window to display the gradient line associated with the specific unit of measurement.

14. The system of claim 13, further comprising patient weight information printed on the base label.

15. The system of claim 14, wherein the patient weight information includes a corresponding numeric amount of dose to be administered.

16. A method for measuring material dispensed from a container, the method comprising:
adhering a base label to the container, the base label having a front surface with printed units of measurement;
covering at least a portion of the front surface of the base label with a rotating top label;
placing a transparent window within a portion of the rotating top label, the transparent window allowing at least a portion of the units of measurement to be visible through the transparent window;
allowing the top label to rotate such that a specific unit of measurement is visible through the transparent window;
displaying a gradient line associated with the specific unit of measurement; and
dispensing material from the container into a predetermined second container, the material dispensed until it is at or near a level on the predetermined second container approximated by the gradient line.

17. The method of claim 16, wherein the material is liquid, solid or any combination thereof.

18. The method of claim 16, wherein the predetermined second container is any of a cup, a syringe, a spoon, or a dropper.

19. The method of claim 16, wherein the specific unit of measurement is any of milliliters, teaspoons, tablespoons, drops, grams, or milligrams.

20. The method of claim 16, wherein the gradient line aligns with a scale at a position corresponding to the specific unit of measurement.
